(19) United States
(12) Patent Application Publication
(10) Pub. No.: US 2006/0256017 A1
(43) Pub. Date: Nov. 16, 2006

(54) Antenna module and radio apparatus using the same

(76) Inventor: Toshio Ishizaki, Hyogo (JP)

Correspondence Address: WENDEROTH, LIND & PONACK L.L.P., 2033 K. STREET, NW, SUITE 800, WASHINGTON, DC, 20006, US

(21) Appl. No.: 11/430,941

(22) Filed: May 10, 2006

(30) Foreign Application Priority Data
May 16, 2005 (JP) 2005-142670

(51) Int. Cl. H01Q 1/38

(52) U.S. Cl. 343/700 MS

(57) ABSTRACT

An antenna module includes a block, an antenna element provided on the block, and an antenna terminal connected with the antenna element. The block has a first surface and a second surface different from the first surface. The antenna element is provided on the first surface of the block. The antenna terminal is provided on the second surface of the block. This antenna module allows a radio apparatus to have a small size.

### FIELD OF THE INVENTION

The present invention relates to an antenna module and a radio apparatus including the module.

### BACKGROUND OF THE INVENTION

Radio apparatuses have been recently required to have small sizes according to technological development of mobile communications.

FIG. 8 is a perspective view of conventional radio apparatus 101. Antenna element 103 and another circuit component 104, such as a control circuit for controlling a signal from antenna element 103, are mounted on mother board 102. Space 105 is provided on mother board 102 between antenna element 103 and another circuit component 104 for improving radiation efficiency of antenna element 103. Space 105 enlarges radio apparatus 101.

### SUMMERY OF THE INVENTION

An antenna module includes a block, an antenna element provided on the block, and an antenna terminal connected with the antenna element. The block has a first surface and a second surface different from the first surface. The antenna element is provided on the first surface of the block. The antenna terminal is provided on the second surface of the block.

This antenna module allows a radio apparatus to have a small size.

### BRIEF DESCRIPTION OF THE DRAWINGS

FIG. 1 is a perspective view of a radio apparatus in accordance with Exemplary Embodiment 1 of the present invention.

FIG. 2 is a sectional view of the radio apparatus at line 2-2 shown in FIG. 1.

FIG. 3 is a perspective view of a board of an antenna module in accordance with Embodiment 1.

FIG. 4 is a sectional view of an antenna module in accordance with Exemplary Embodiment 2 of the invention.

FIG. 5 is a sectional view of an antenna module in accordance with Exemplary Embodiment 3 of the invention.

FIG. 6 is a perspective view of a board of another antenna module in accordance with Embodiment 3.

FIG. 7 is a sectional view of still another antenna module in accordance with Embodiment 3.

FIG. 8 is a perspective view of a conventional radio apparatus.

### DETAILED DESCRIPTION OF THE PREFERRED EMBODIMENTS

### Exemplary Embodiment 1

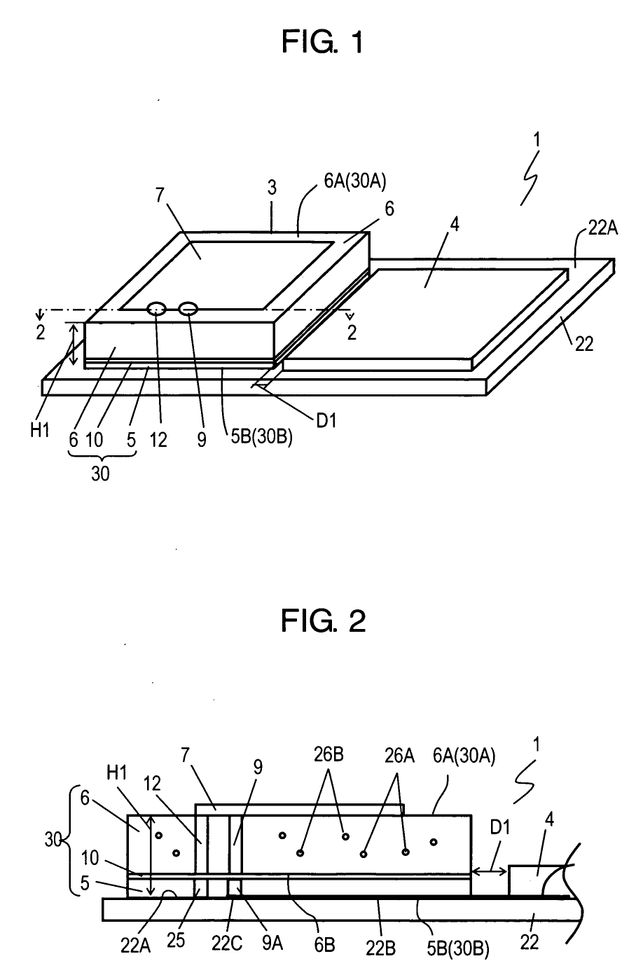

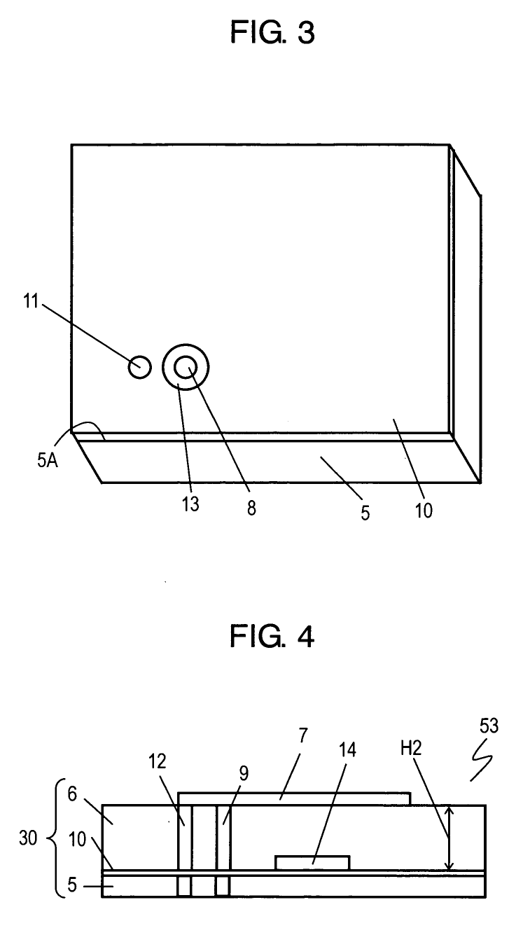

FIG. 1 is a perspective view of radio apparatus 1 in accordance with Exemplary Embodiment 1 of the present invention. FIG. 2 is a sectional view of antenna module 3 at line 2-2 shown in FIG. 1. FIG. 3 is a perspective view of board 5 of antenna module 3.

Radio apparatus 1 includes mother board 22, antenna module 3 mounted on surface 22A of mother board 22, and circuit component 4 mounted on surface 22A. Antenna module 3 includes block 30 provided on mother board 22 and antenna element 7 provided on block 30. Block 30 has surface 30B contacting surface 22A and has surface 30A opposite to surface 30B. Surface 30B is different from surface 30A. Surface 30A has an insulating property. Block 30 includes insulating board 5, ground plate 10 provided on insulating board 5, and insulating resin member 6 provided on ground plate 10. Insulating board 5 has surface 5B contacting surface 22A of mother board 22, and has surface 5A opposite to surface 5B. That is, surface 5B of board 5 is surface 30B of block 30. Ground plate 10 has surface 10B contacting surface 5A of board 5, and has surface 10A opposite to surface 10B. Resin member 6 has surface 6B contacting surface 10A of ground plate 10, and has surface 6A opposite to surface 6B. Antenna element 7 is provided on surface 6A of resin member 6. That is, surface 6A of resin member 6 is surface 30A of block 30. Feeding pad 8 on surface 5A of board 5 is connected electrically to antenna element 7 through via-conductor 9 penetrating resin member 6. Short-circuit pad 11 on surface 10A of ground plate 10 is coupled electrically to antenna element 7 through via-conductor 12 penetrating resin member 6. Antenna terminal 9A is provided on surface 22A of mother board 22 for outputting a signal from feeding pad 8 to terminal 22C on surface 22A of mother board 22. Ground terminal 25 coupled electrically with ground plate 10 is provided on surface 5B of board 5. Circuit pattern 22B is provided on surface 22A of mother board 22. Antenna terminal 9A is connected with circuit pattern 22B connected with component 4. Board 5 is a resin board, such as Any Layer Inner Via Hole (ALIVH) multilayer board. While board 5 has ground plate 10 on surface 5A thereof, clearance 13 separates ground plate 10 electrically from feeding pad 8.

Resin member 6 is made of resin, such as epoxy base resin, polyphenylene ether or polytetrafluoro-ethylene. Dielectric particles 26A, such as ceramics, may be dispersed in resin member 6. Dielectric particles 26A have preferably a dielectric constant larger than that of resin member 6. Dielectric particles 26A can shorten the element length of antenna element 7, thus reducing the area of antenna element 7 and allowing antenna module 3 to have a small size. Magnetic particles 26B, such as ferrite, may be dispersed in resin member 6. Magnetic particles 26B have preferably a magnetic permeability larger than that of resin member 6. Magnetic particles can shorten the element length of antenna element 7, thus reducing the area occupied by antenna element 7 and allowing antenna module 3 to have a small size. Electrical characteristics or mechanical characteristics, such as a relative dielectric constant or magnetic permeability, of resin member 6 can be changed by changing the composition of dielectric particle 26A or magnetic particle 26B in resin member 6 or by changing a method of mixing the particles, thereby increasing flexibility of designing. This allows antenna module 3 to have a small size, a large gain, and a wide bandwidth.

Antenna element 7 is made of electric conductor, such as metal.

Circuit component 4 and block 30 provided on surface 22A of mother board 22 are separated from each other by distance D1. In antenna module 3, height H1 of block 30 provides a distance between antenna element 7 and circuit component 4 which is longer than distance D1. This arrangement can shorten distance D1 between antenna module 3 and circuit component 4, accordingly allowing mother board 22 and radio apparatus to have small sizes. Antenna terminal 9A for outputting a signal from antenna element 7 to an outside of antenna module 3 is provided on surface 5B of board 5. This arrangement allows antenna module 3 to be provided on surface 22A of mother board 22 by soldering antenna terminal 9A to circuit pattern 22B, thus increasing flexibility in the mounting of antenna module 3 to mother board 22. As a result, antenna module 3 can be easily handled as a surface mounting device.

### Exemplary Embodiment 2

FIG. 4 is a sectional view of antenna module 53 in accordance with Exemplary Embodiment 2 of the present invention. In FIG. 4, components similar to those of antenna module 3 shown in FIGS. 1 to 3 are denoted by the same reference numerals, and their descriptions are omitted. In antenna module 53, resin member 6 accommodates circuit component 14 therein.

Circuit component 14 is provided on surface 5A of board 5, is covered with resin member 6, and processes a signal from antenna element 7. Circuit component 14 may be a device, such as a bare chip of a semiconductor. For example, circuit component 14 may be an impedance control circuit for controlling a load impedance of antenna element 7, or a weighing circuit for controlling the amplitude and phase of an input/output signal of antenna element 7.

Antenna module 53 itself accommodates circuit component 14 therein for processing a signal from antenna element 7, thereby reducing the number of circuit components to be arranged on mother board 22 to reduce the size of radio apparatus 1. In addition, resin member 6 can protect circuit component 14. Height H2 of resin member 6 enlarges the distance between circuit component 14 and antenna element 7, preventing circuit component 14 from reducing the radiation efficiency of antenna element 7.

Circuit component 14 may be a high frequency filter, such as a dielectric filter, a LTCC filter, or a SAW filter. Such high frequency filter is often used while electrically coupled with antenna element 7. The high frequency filter accommodated in resin member 6 is effective for reducing the size of radio apparatus 1 and for providing a high efficiency of antenna module 53. Besides, circuit component 14 (high frequency filter) is integrated in antenna element 7 as a single module. This structure consequently maintains the electrical distance between antenna element 7 and circuit component 14 in constant, thereby fixing a reflecting phase of an extraneous signal at a predetermined frequency. Accordingly, as described in following Exemplary Embodiment 3, in the case that plural antenna elements are accommodated in antenna module 3, interference between antenna elements can be easily fixed.

### Exemplary Embodiment 3

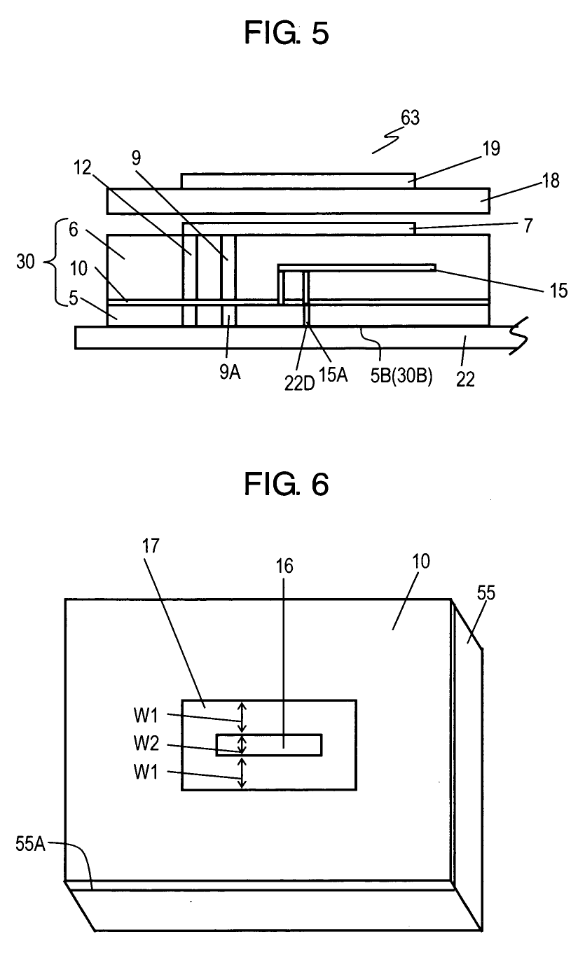

FIG. 5 is a sectional view of antenna module 63 in accordance with Exemplary Embodiment 3 of the present invention. In FIG. 5, components similar to those of antenna module 3 shown in FIGS. 1 to 3 are denoted by the same reference numerals, and their descriptions are omitted. Antenna module 63, in addition to antenna element 7, further includes antenna element 15 accommodated in resin member 6. Antenna terminal 15A is provided on surface 5B of board 5 and outputs a signal from antenna element 15 to terminal 22D on surface 22A of mother board 22. Antenna terminal 9A and antenna terminal 15A may be incorporated in a single terminal.

Antenna module 63 can receive a radio wave by a dual method or a diversity method with using antenna elements 7 and 15. The diversity method, such as a space diversity method, a time diversity method, a polarization diversity method, or a frequency diversity method improves receiving characteristics of antenna module 63.

Resin member 18 may be stacked on antenna element 7. Resin members 6 and 18 may be made of material identical to each other or materials different from each other. Resin members 6 and 18 may be unified and cover antenna element 7 completely. Metal plate 19 may be provided on resin member 18. Metal plate 19 functions as a shield for shielding a radio wave, reducing interference of a signal received by antenna element 7 with another signal.

FIG. 6 is a perspective view of board 55 of another antenna module in accordance with Embodiment 3. Pattern antenna element 16 is provided on surface 55A of board 55. Gap 17 is provided between pattern antenna element 16 and ground plate 10. Width W1 of gap 17 is preferably wider than width W2 of pattern antenna element 16 for improving the radiation efficiency of pattern antenna element 16.

This antenna module can receive a radio wave by a dual method or a diversity method with using antenna element 7 and pattern antenna element 16, thereby improving the receiving characteristics of the antenna module.

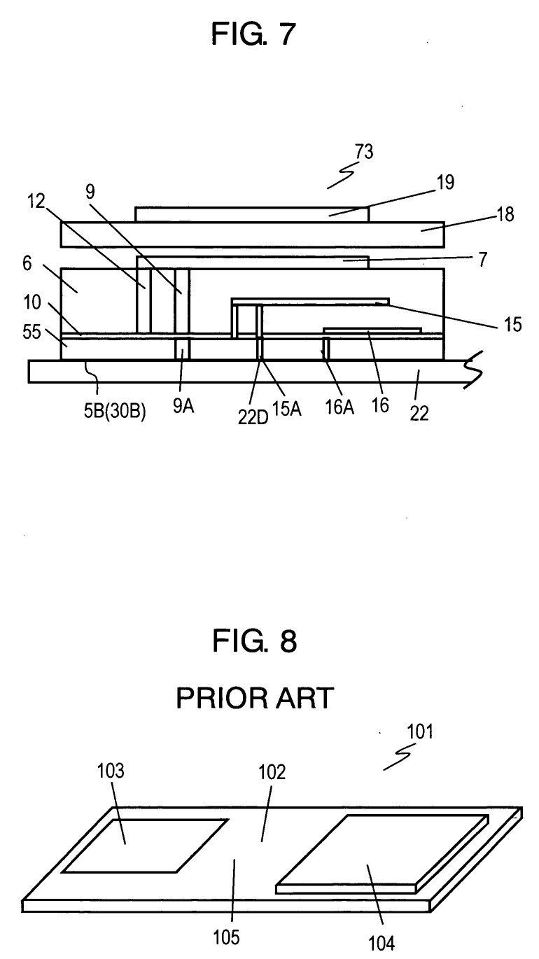

FIG. 7 is a sectional view of still another antenna module 73 in accordance with Embodiment 3. In FIG. 7, components similar to those of antenna module 63 shown in FIG. 5 are denoted by the same reference numerals, and their descriptions are omitted. Antenna module 73, in addition to antenna module 63, further includes pattern antenna element 16. Antenna terminal 16A connected with pattern antenna element 16 is provided on surface 55B of board 55.

Antenna module 73 can receive a radio wave by a diversity method with using the three antenna elements, i.e., antenna element 7, antenna element 15, and pattern antenna element 16. The antenna module of Embodiment 3 may includes more antenna elements, and receive a radio wave by a diversity method with using these antenna elements, thereby improving the receiving characteristics of the antenna module.

A radio apparatus including the antenna module according to the present invention have a small size, accordingly being used in a mobile terminal, such as a television receiver, mounted on a vehicle.

What is claimed is:

1. An antenna module comprising:
a block having a first surface and a second surface that is different from the first surface;
a first antenna element provided on the first surface of the block; and
a first antenna terminal provided on the second surface of the block and connected with the first antenna element.

2. The antenna module of claim 1, wherein the block includes a resin member having a surface which is the first surface of the block.

3. The antenna module of claim 2, wherein the block further includes dielectric particles dispersed therein, the dielectric particles having a dielectric constant larger than a dielectric constant of the resin member.

4. The antenna module of claim 2, wherein the block further includes magnetic particles dispersed therein, the magnetic particles having a magnetic permeability larger than a magnetic permeability of the resin member.

5. The antenna module of claim 1, further comprising a circuit component covered with the resin member and processing a signal from the first antenna element.

6. The antenna module of claim 5, wherein the circuit component is a high frequency filter.

7. The antenna module of claim 1, further comprising:
a second antenna element covered with the block; and
a second antenna terminal provided on the second surface of the block and connected with the second antenna element.

8. The antenna module of claim 1, further comprising:
a resin member provided on the first antenna element; and
a metal plate provided on the resin member.

9. A radio apparatus comprising:
a mother board;
an antenna module including
a block mounted on the mother board and having a first surface and a second surface different from the first surface,
a antenna element provided on the first surface of the block, and
a antenna terminal provided on the second surface of the block and connected with the antenna element; and
a circuit component provided on the mother board and electrically coupled with the antenna terminal.
